(19) United States
(12) Patent Application Publication
(10) Pub. No.: US 2004/0125272 A1
(43) Pub. Date: Jul. 1, 2004

(54) Flat panel display with polymer memory provided thereon

(76) Inventors: David B. Chung, Cupertino, CA (US); Kurt Sehnert, San Jose, CA (US)

Correspondence Address: KENYON & KENYON, 1500 K STREET, N.W., SUITE 700, WASHINGTON, DC, 20005, US

(21) Appl. No.: 10/330,483

(22) Filed: Dec. 30, 2002

(51) Int. Cl. G02F 1/133

(52) U.S. Cl. 349/73

(57) ABSTRACT

A flat panel display system includes a polymer memory provided thereon. The flat panel display may include a viewable portion and a non-viewable portion. In an embodiment, the polymer memory system may be provided on a non-viewable planar surface of the display. Owing to the large viewable area of many flat panel displays, it is expected that the polymer memory system can provide a large memory for a computer or other processor-based device without requiring any change in the device's form factor. Thus, such a system finds ready application in notebook computers, personal digital assistance and other mobile processor-based devices.

### BACKGROUND

Battery-powered processing devices are subject to several different competing design criteria. For example, increasing the processing power of a computer's central processing unit or the amount of RAM memory provided thereon generally causes a corresponding increase in the rate at which the computer consumes power. Engineers are constantly challenged to design devices that provide increased processing power and increased storage capacity while, at the same time, prolonging battery life and decreasing the physical dimensions of those devices. Engineers are most acutely aware of these design constraints when designing processing systems for mobile applications, such as notebook computers, portable digital assistants, mobile phones, global positioning system (“GPS”) devices, automotive systems and other battery-powered devices.

Substantial research and development is underway in the area of polymer memories. Polymer memories are unlike traditional silicon-based RAM devices because, as their name implies, they are manufactured from polymers. Individual memory cells include a polymer material having a dipole moment. The orientation of the dipole moment may be controlled selectively to represent stored data. Polymer memories can be advantageous for battery-powered devices because stored data remains valid even when power is removed from the memory system.

The inventors have investigated polymer memories for battery-powered processing devices and have identified a need in the art for such a processing device that integrate polymer memories therein without increasing the form factor of the device.

### BRIEF DESCRIPTION OF THE DRAWINGS

FIG. 1 is an exploded view of a display according to an embodiment of the invention.

FIG. 2 is a block diagram of a display according to an embodiment of the invention.

FIG. 3 is an exploded view of a display according to another embodiment of the invention.

FIG. 4 is an exploded view of a display according to an additional embodiment of the invention.

FIG. 5 is an exploded view of a display according to another embodiment of the invention.

FIG. 6 is a diagram of a polymer memory system according to an embodiment of the present invention.

FIG. 7 is a block diagram of a processor system according to an embodiment of the present invention.

### DETAILED DESCRIPTION

Embodiments of the present invention provide a flat panel display system that includes a polymer memory provided thereon. The flat panel display may include a viewable portion fabricated according to any of the well-known techniques for such displays. In an embodiment, the polymer memory system may be provided on a non-viewable planar surface of the display. In other embodiments, the polymer memory system may be provided in a layer that lies within an active optical region of the display but distribution of memory cells is made sparsely so as not to interfere with the optical properties of the display. Owing to the large viewable area of many flat panel displays, it is expected that the polymer memory system can provide a large memory for a computer or other processor-based device without requiring any change in the device's form factor. Thus, such a system finds ready application in notebook computers, portable digital assistants, mobile phones, global positioning system (“GPS”) devices, automotive systems and other battery-powered processing systems.

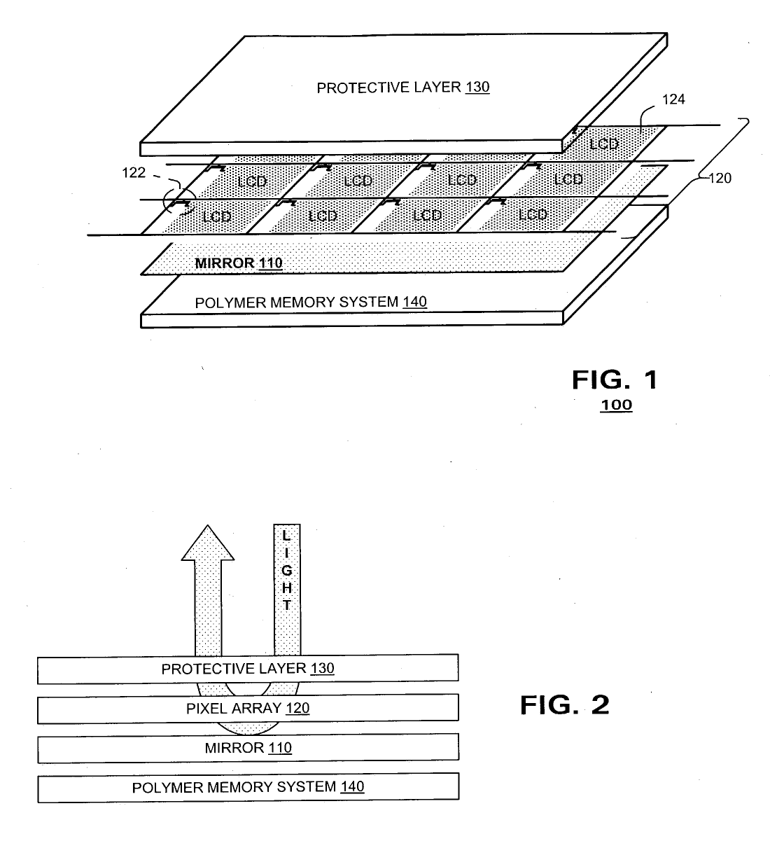

FIG. 1 is a simplified exploded view of a reflective liquid crystal display (“LCD”) 100 according to an embodiment of the present invention. The reflective LCD 100 may include a mirror 110, an array 120 of LCD pixels and a protective layer 130 provided in a stacked relationship. The pixel array 120 is formed on a first side of the mirror. The pixel array 120 may include a plurality of thin film transistors (“TFTs”) 122 and LCD elements 124. In response to a control signal, each TFT 122 may cause a respective LCD element 124 to become either opaque or transparent to light. In this manner, the LCD elements 124 form images on the display 100. In this regard, the structure and operation of a reflective LCD 100 is well known.

According to an embodiment, a polymer memory system 140 may be formed on the mirror 110. The polymer memory system 140 may be provided on a non-viewable side of the mirror 110, that is, opposite to the side on which the pixel array 120 is provided. Conventionally, mirrors in reflective LCD displays are of a size that equals the viewable area of the display. Thus, in an 8 inch by 6 inch display, the mirror have an area of 48 square inches. Almost the entire area of the mirror 110 may be used for the polymer memory system 140.

FIG. 2 illustrates the optical characteristics of the display 100 of FIG. 1 in an embodiment. As is known, reflective displays do not include their own light source. Instead, light from an external source enters the display 100, propagates through the protective layer 130, the pixel array 120 and any other optical devices provided therein until it reaches the mirror 110. The mirror 110 reflects the light. Reflected light propagates back through the pixel array 120 and the protective layer 130 and exits the display. The polymer memory system 140, because it is provided on the reverse side of the mirror, does not interfere with the operation of the display.

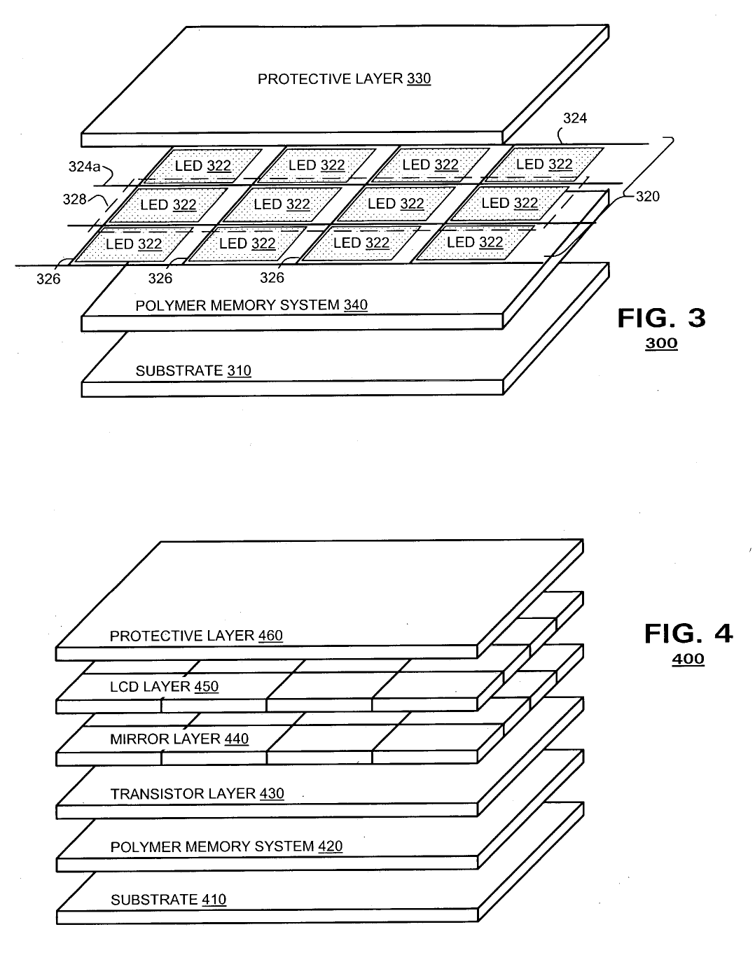

FIG. 3 is a simplified exploded view of a flat panel display 300 according to another embodiment of the present invention. In this embodiment, the display 300 may include a plurality of light emitting diodes (“LEDs”) provided in an array of pixels. The display may include a substrate 310 formed of a sufficiently rigid material to support the LEDs. The substrate 310 may be a mirror or other reflective surface but, in other embodiments, the substrate simply may be a non-reflective support (e.g., glass). A pixel array 320 and a protective layer 330 may be provided over the substrate in a stacked relationship.

In the embodiment of FIG. 3, LEDs 322 in the pixel array 320 may be fabricated from materials that emit light when subject to electrical control signals. Organic light emitting diodes are one example of such materials. The light emitting materials may be selected to support a red-green-blue color scheme or any other color scheme that may be desired. The pixel array 320 may include two sets of conductors, row control lines 324 and column control 326 lines, provided throughout the array 320. By driving a select control line in the first set of conductors (say, a selected row control line 324a), a driving potential may be established across input terminals of each of the LEDs 322 in a line 328 across the display. By driving each conductor of the second set individually (each of the columnar control lines 326), each of the LEDs 322 subject to the driving potential either may become illuminated or remain dark on an individual basis. Driving potentials may be supplied to each row control line of the LED display rapidly in sequence, causing the LED display 300 to carry image information. In this regard, the operation of LED display 300 is well known.

According to an embodiment, a polymer memory system 340 may be provided in a layer in an optically active portions of the display, such as between the substrate 310 and the pixel array 320. Conventionally, the substrate 310 of a LED display 300 occupies an area that is commensurate with the viewable surface area of the display itself. Thus, the polymer memory system 340 may occupy an area that matches the viewable area of the LED display 300.

During operation, as the LEDs are activated and deactivated, emitted light exits the display through the protective layer 330. Emitted light that initially propagates from the LEDs toward the substrate 310 propagates through the polymer memory system 340 and either is reflected back toward the protective layer 330 or is absorbed by the substrate 310, depending upon the materials chosen for the substrate 310.

FIG. 4 is a simplified view of a flat panel display 400 according to another embodiment of the present invention. In this embodiment, the display may include a planar substrate 410, a polymer memory system 420, a layer of TFTs 430 (transistor layer), a layer of mirrors 440, a layer of LCD cells 450 and a protective layer 460, all formed in a stacked relationship. This embodiment illustrates a distributed pixel array in which the transistors that control the LCD cells are provided in a layer that is behind the mirror layer 440. In this embodiment, although the transistor layer 430 and the polymer memory system 420 are illustrated as being present in separate planes, they may be integrated into a single layer if desired to simplify manufacturing processes.

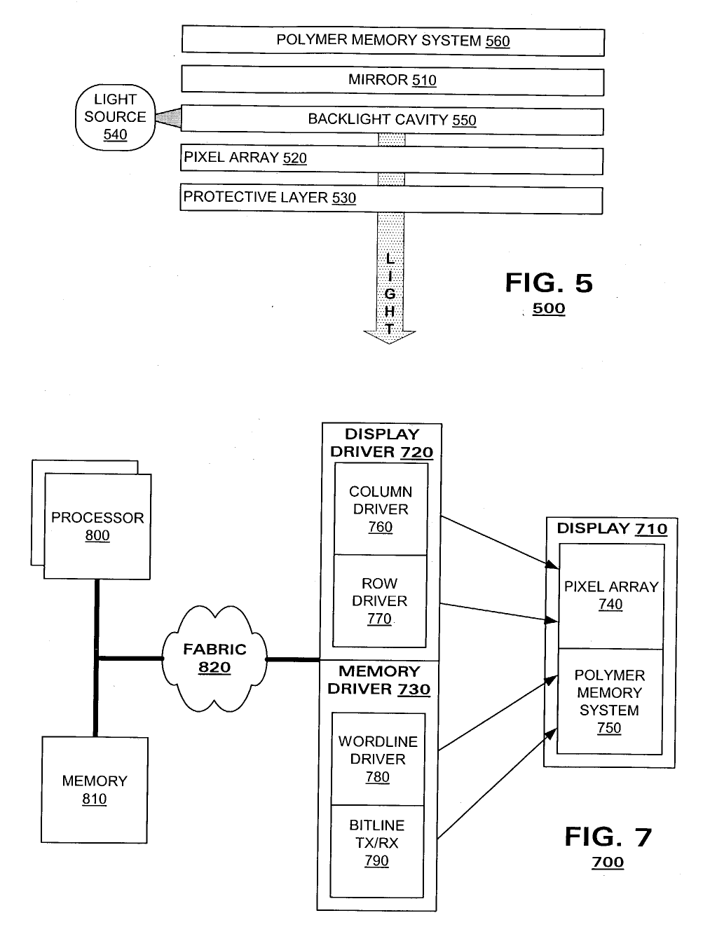

FIG. 5 illustrates a flat panel display 500 according to another embodiment of the present invention. In this embodiment, the display may include a mirror 510, a pixel array 520 and a protective layer 530, provided in a stacked relationship. A light source 540 may shine light into a backlight cavity 550 formed by the mirror and the pixel array. In this embodiment, the pixel array 520 may include its own substrate (not shown) on which TFTs and LCDs are formed.

In this embodiment, a polymer memory system 560 may be provided on a side of the mirror 510 away from the image-bearing surface of the display. The polymer memory system 560, because it is provided on a reverse side of the mirror, does not interfere with the ordinary functions of the display. The polymer memory system 560 may be provided to cover the entire rear surface of the mirror 510, subject to operational constraints that may be imposed by any heat generated by the light source 540.

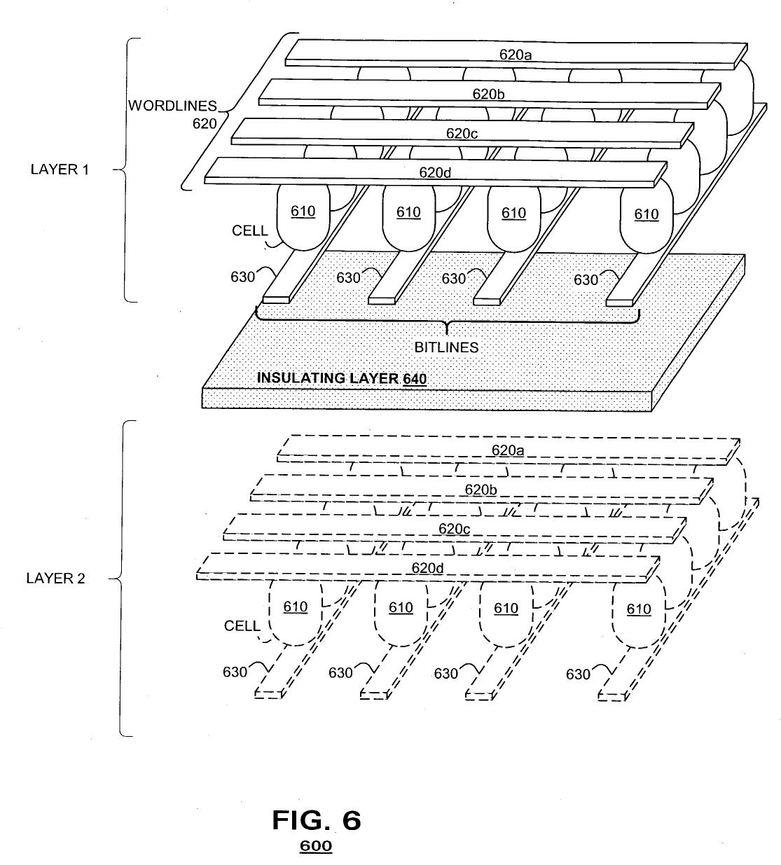

FIG. 6 illustrates the architecture of a polymer memory system 600 according to an embodiment of the invention. The memory system 600 may include a plurality of memory cells 610 provided along a planar surface of the system. The cells are provided between a first plurality of conductors, called wordlines 620, and a second plurality of conductors, called bitlines 630. The polymer materials of the cells 610 themselves are characterized by a dipole moment, whose orientation can be controlled to represent stored information. During a reading operation, a driving potential may be applied to one of the wordlines (say, 620d). The orientation of the dipole moment of each cell provided along the wordline 620d may cause a current to be generated (or not) on an associated bitline 630a-630d. A sense amplifier (not shown) provided on a terminal end of each bit line may detect the presence or absence of current on the associated bitline as binary data.

In those embodiments in which the polymer memory systems are provided in a non-viewable layer of a display, for example, behind a reflective mirror or opaque substrate, there is no limit to the packing density of the memory cells beyond those limitations of the memory structure itself. In those embodiments in which the polymer memory system is provided in a viewable area of the display, it may be appropriate to limit the packing density to approximately one memory cell per switching transistor of the associated pixel array. In a 1024×768 pixel display, for example there are three TFTs per pixel—one for each color component of the display (e.g., red-green-blue). Such an embodiment, would provide approximately 2.36 megabit storage capacity. Similarly, a 640×480 pixel display would have a 921 kilobit storage capacity. As display sizes increase, the numbers of pixels on the display also will increase; in the foregoing embodiment, the size of the polymer memory systems can increase correspondingly. For example an 8192×6144 pixel display and a 65536×49152 pixel display would provide storage capacities of 1,509 million bits and 9,663 million bits, respectively. Other implementations certainly are possible.

The capacity of a polymer memory system 600 may be increased by providing a plurality of layers of memory cells in the polymer memory system 600. Accordingly, in an embodiment, the memory system 600 may include a plurality of layers (only two are shown in FIG. 6), where each layer includes an array of memory cells 610, a set of wordlines 620 and a set of bitlines 630. Layers may be separated from each other by an interstitial insulative layer 650 to mitigate noise effects that might extend from one layer to the next. The layers need not be provided identically to one another. For example, rather than stack individual cells 610 directly on top of one another, a cell in one layer may be placed in a location that is occupied by a space between cells in another layer. Further, wordlines 620 from one layer need not run parallel to wordlines 620 from another layer. Similarly, bitlines from one layer need not run parallel to bitlines from another layer. Additionally, rather than providing wordlines from one layer adjacent to bitlines of another layer, it may be beneficial to provide wordlines from each layer in an adjacent relationship or bitlines from each layer in an adjacent relationship. Such embodiments are within the spirit and scope of the present invention.

FIG. 7 illustrates a processor-based system 700 in which, according to an embodiment, the prior display embodiments may be used. The system 700 may include a display driver 720 and memory driver 730. As these names imply, the display driver 720 controls the pixel array 740 of the display 710 and causes it to display image information. The memory driver 730 controls the polymer memory system 750 of the display 710, causing it to read or write data. The display driver 720 includes column drivers 760 and row drivers 770 to generate appropriate signals to the pixel array 740. The memory driver 730 may include wordline drivers 780 and bitline drivers 790 to read or write data from desired cells of the polymer memory system. According to an embodiment, the display driver 730 and memory driver 740 may be provided as conventional integrated circuits on an expansion card or the like of a larger processor-based system, to be accessed by one or more processors 800, a silicon-based memory system 810 or other integrated circuits via a communication link (shown generally as “fabric” 820).

The polymer memory systems of the foregoing embodiments may be provided as general purpose random access memory (“RAM”) for storage of any kind of data to be used by a processor-based system 700. As is known, polymer memories are non-volatile; stored data remains valid in the memory even after power is removed. Thus, polymer memories are expected to find ready application in a variety of battery-powered processor-based systems 600, such as laptop/notebook computers, personal digital assistants, mobile phones and the like. By storing application data in a polymer memory, one may avoid many power-intensive operations such as loading an operating system on device start-up from a mechanical storage device such as a magnetic or optical disc. The present invention permits a large scale memory system to be integrated into a display to be used in such systems with almost no increase in the physical dimensions of the display.

As shown in the foregoing discussion, embodiments of the present invention are proposed for use in flat panel displays of various structures. It is an advantage of these embodiments that one may introduce a polymer memory system into a display without a substantial redesign of the display itself. Accordingly, the figures used herein above have provided a simplified illustration of the display structures themselves and have omitted, several elements that are commonly used in such displays such as capacitors, color filters, polarizing filter and other optical elements. Such omissions were made merely to keep the presentation of the foregoing embodiments a clear one.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A flat panel display, comprising:
a substrate having two opposing surfaces,
an image display system provided on one of the surfaces of the substrate, and
a polymer memory system provided on the other of the surfaces of the substrate.

2. The flat panel display of claim 1, wherein the substrate is a mirror reflective on at least one side.

3. The flat panel display of claim 1, wherein the image display system is a reflective LCD system.

4. The flat panel display of claim 1, wherein the image display system is a backlit LCD system.

5. The flat panel display of claim 1, wherein the image display system is an LED system.

6. The flat panel display of claim 1, wherein the polymer memory system comprises a plurality of addressable storage cells of a polymer material having a dipole moment.

7. The flat panel display of claim 6, wherein the polymer memory further comprises:
a plurality of parallel wordlines provided on one side of the cells,
a plurality of parallel bitlines provided on another side of the cells.

8. The flat panel display of claim 6, wherein the cells are provided in a plurality of stacked layers, each layer parallel to one of the surfaces of the substrate.

9. A display system, comprising:
the flat panel display of claim 1, and
a control system, comprising:
a display driver electrically coupled to the image display system, and
a memory driver electrically coupled to the polymer memory system.

10. A system, comprising:
a processor, a silicon-based memory and a flat panel display, each provided in electrical communication with the other,
wherein the flat panel display comprises a polymer memory system provided on an interior surface thereof.

11. The system of claim 10, wherein the system is provided in a battery-powered computer.

12. The system of claim 10, wherein the system is provided in a mobile phone.

13. The system of claim 10, wherein the flat panel display is a reflective LCD system.

14. The system of claim 10, wherein the flat panel display is a backlit LCD system.

15. The system of claim 10, wherein the flat panel display is an LED system.

16. A method, comprising retrieving data from a polymer memory system provided in a flat panel display.

17. The method of claim 16, wherein the retrieving comprises:
driving a wordline in the polymer memory system to select a predetermined number of polymer memory cells,
detecting current on a plurality of bitlines associated with the selected memory cells,
from the detected currents, generating a data value.

18. The method of claim 17, further comprising transferring the data value to a processor.

19. The method of claim 17, further comprising transferring the data value to another memory.
